(19) United States
(12) Patent Application Publication
(10) Pub. No.: US 2013/0140280 A1
(43) Pub. Date: Jun. 6, 2013

(54) ARC WELDING DEVICE AND PROCESS USING A MIG/MAG TORCH COMBINED WITH A TIG TORCH

(71) Applicants: Laurent Biskup, Houston, TX (US); Jean-Pierre Planckaert, Houston, TX (US)

(72) Inventors: Laurent Biskup, Houston, TX (US); Jean-Pierre Planckaert, Houston, TX (US)

(21) Appl. No.: 13/817,194

(22) PCT Filed: Jul. 27, 2011
(86) PCT No.: PCT/FR2011/051802

§ 371 Date: Feb. 15, 2013

(30) Foreign Application Priority Data
Aug. 17, 2010 (FR) 1056621

(51) Int. Cl. B23K 9/173; B23K 9/167

(52) U.S. Cl. CPC B23K 9/1735; B23K 9/167
USPC 219/74; 219/137 R

(57) ABSTRACT

The invention relates to a device and a process for the arc welding of metal workpieces employing a MIG/MAG welding torch combined with a TIG welding torch so as to operate simultaneously and to obtain welded joints free of protruding defects.

The invention relates to a device and process for arc welding metal workpieces using a MIG/MAG welding torch associated with a TIG welding torch, these torches being able and designed to operate simultaneously and to produce weld joints free of humping.

MIG or MAG welding—standing for “metal inert gas” and “metal active gas” welding, respectively—refers to welding or braze-welding techniques that use an electric arc, a consumable electrode and a shielding gas, especially to weld sheets, whether coated or not.

During the implementation of these MIG/MAG processes, the heat given off by the electric arc melts the end of the filler metal, i.e. of the consumable wire, and optionally the base metal, i.e. the metal or metal alloy of the workpieces to be welded. A gas or a gas mixture conventionally shields the molten puddle around the weld joint being formed from atmospheric contaminations during welding.

A MIG/MAG arc welding device comprises a MIG/MAG torch, an electrical power supply, a control circuit and a consumable metal wire or electrode positioned near, especially above, one or more workpieces to be welded, on which a weld must be produced. The device furthermore comprises means for moving the welding torch along the weld to be produced.

In order to increase the productivity of the welding operation, especially when joining thin sheets, there are various known methods, namely increasing the rate of advance of the welding torch, cutting back on finishing or preparatory work, or decreasing the rejection rate.

The first method has the drawback of causing welding defects when the welding speed, i.e. the speed at which the torch is moved, exceeds a certain limit. The weld bead profile then exhibits a periodic undulation called “humping”, i.e. humps form in the profile. This visible defect may also have an adverse affect on the mechanical strength of the weld. It limits the range of welding speeds that can be used and prevents the productivity of the welding operation from being increased.

Humping defects mainly appear in two forms in MIG/MAG welding, namely in gouging region morphology (GRM) or beaded cylinder morphology (BCM).

In fact, the formation mechanism of humping is complex because it depends on fluid mechanics (molten metal), thermomechanics, and the physics of electric arcs. For example, the appearance of a BCM humping defect seems to be related to poor wetting, generating a pinch instability analogous to a Rayleigh-Taylor instability.

There are various methods that allow the welding speed to be increased, all of which have drawbacks, namely:
preheating the sheets to be welded. However, this method is difficult to implement because it is essential to control the initial temperature of the sheet in order to obtain reproducible results. Furthermore, a certain amount of power is consumed heating all of the workpieces to be welded;
preceding the MIG/MAG torch with an unfocused laser beam in order to preheat the sheet before the MIG/MAG arc and create a thin film of liquid metal. However, this method is expensive because it requires a laser source able to provide at least 3 kW of power;
tandem welding with two MIG torches in order to lengthen the weld puddle by using two MIG arcs. However, this solution requires a substantial investment and is expensive to implement because it requires two pay-out systems and the use of two MIG/MAG generators, and the generators need to be synchronized in order to prevent attraction between the arcs. In addition, tandem welding makes it impossible to control the heat flow and pressure delivered by the arc, with a view to preventing humping, independently of the feed of wire; and
combining keyhole plasma arc welding with MIG welding such that the plasma arc strikes the sheets before the MIG arc in order to ensure a good penetration, then filling the holes created by the plasma arc. The results obtained are good but this process is relatively to implement, in particular the keyhole plasma must be set up very precisely, and the small distance between the MIG arc and the plasma arc leads to adverse interactions between the arcs.

With regard to the above, the problem to be solved is how to overcome all or some of the drawbacks mentioned above, i.e., in particular, how to provide a MIG/MAG welding device that can weld at a high welding speed without causing humping to appear, which device is both simple to implement and/or does not require too much power.

The solution of the invention thus relates to a device for arc welding metal workpieces comprising a MIG or MAG welding torch associated with a TIG welding torch in a way allowing these torches to operate simultaneously, characterized in that said MIG/MAG welding torch comprises a wire guide allowing a consumable wire to be guided in a given first direction and the TIG welding torch comprises a nonconsumable electrode pointed in a given second direction, said first and second directions being substantially coplanar and forming an angle α larger than 5° and smaller than 40°, and the electrode of the TIG welding torch comprises a tip D located a distance ‘d’ of between 20 and 44 mm from said first direction 1b.

According to the invention, the MIG/MAG welding torch is able to produce a raw weld bead in the joint plane located at the junction between the workpieces to be welded, while the TIG welding torch, which is securely fastened to the MIG/MAG welding torch, can operate simultaneously with the MIG/MAG welding torch so as to produce an electric arc that strikes the raw weld bead so as to obtain a final bead that is free or almost free of humping.

Indeed, the proximity between the two arcs and their rapid succession over a given zone of the joint means that this given zone of the joint is struck, in succession, first by the MIG/MAG arc, and then by the TIG arc while the metal of this joint zone is still liquid, i.e. still molten after the passage of the MIG/MAG arc.

It follows that the TIG arc will act on the weld puddle formed by the MIG/MAG arc while it is still liquid, and the weld puddle will then benefit from the heat flow generated by the TIG arc, so as not to solidify, but also from the pressure exerted by this arc on the hump of molten metal formed at the back end of the puddle, thereby allowing a weld bead that is free, or almost free, of humping to be obtained.

It should be highlighted that the expression “metal workpieces” is understood to mean a plurality of separate metal workpieces but also a single workpiece to be welded to itself, for example two longitudinal edges of a metal sheet to be welded to form a tube.

The MIG or MAG torch used comprises a wire guiding system comprising a wire guide intended to guide at least one consumable wire as far as the outlet of the torch, which outlet is located facing the workpieces to be welded, and a nozzle intended to supply inert gas or active gas to nearby the molten zone of the consumable wire.

The consumable wire acts as an electrode and the MIG/MAG torch is supplied with electric power by one or more external power supplies, such as a welding current generator, so as to strike an arc between the consumable wire and the workpieces to be welded, and thus to gradually melt the wire, which is deposited in the joint plane located between the workpieces to be welded, thus forming a raw weld bead.

The torch is moreover supplied with gas originating from a tank or a network of pipes.

The torch is moved relative to the workpieces to be welded by automatic moving means allowing it to move along all or part of the joint plane, i.e. along a given path corresponding to the weld to be produced.

Moreover, according to the invention, a TIG welding torch having a tungsten electrode is associated with the MIG/MAG torch. The expression “TIG torch” is understood to mean a welding system comprising, at the very least, at least one tungsten electrode and a nozzle intended to supply inert gas to the zone of the electric arc created by the torch.

The MIG/MAG and TIG torches may be supplied by the same gas supply, the same power supply or alternatively by different supplies. Likewise, the means for moving the torches may also optionally be common to both torches.

The TIG torch produces an arc allowing the raw weld bead produced by the MIG/MAG torch to be treated, i.e. allowing the weld bead to be heated and acted upon mechanically by the arc pressure, so as to reduce or remove humping from the bead.

The relative speed at which the welding torches are moved, i.e. the welding speed, is significantly increased. It is not necessary to heat a large part of the workpieces to be welded. A quite localized zone of the weld bead is treated a short time after it has formed, and therefore only a moderate amount of power is consumed by the TIG torch.

According to the invention, the expression “associated with the MIG/MAG torch” is understood to mean that the TIG torch is mechanically fastened to the MIG/MAG torch so as to be able to follow its movements and operate simultaneously with it.

Depending on the circumstances, the device of the invention may comprise one or more of the following features:
it furthermore comprises adjustment means, such as one or more cylinders, gearing, etc. allowing adjustment of the relative position of said welding torches relative to each other, i.e. of the distance between said torches or between the latter and the workpieces to be welded, or alternatively of the various angles;
said MIG/MAG welding torch comprises a guide wire allowing a consumable wire to be guided in a given first direction and the TIG welding torch comprises a nonconsumable electrode pointing in a given second direction, said first and second directions being substantially coplanar and forming an angle α of between 0 and 40°, preferably between 0 and 20°, i.e. the two torches are parallel or convergent, one toward the other. In particular, this angle is between 5 and 15 degrees, thereby allowing the welding speed to be increased, all other things being equal. The expression “substantially coplanar” is understood to mean that the distance between the straight lines embodying these directions is smaller than 3 mm and preferably smaller than 1.5 mm. This has the advantage of preventing significant asymmetry in the bead. Beyond these limits, there would be a risk that the bead will be weakened;
the electrode of the TIG welding torch comprises a tip located a distance d of between 20 and 26 mm, or of between 36 and 44 mm, from said first direction. This distance may be defined, geometrically, as the Euclidean distance between the tip of the tungsten electrode, considered to be a point, and its orthogonal projection onto the given first direction (that of the MIG/MAG wire at its exit). This distance range allows the welding speed to be increased, all other things being equal;
the tip of the TIG electrode is located a distance d of between 20 and 26 mm from the first direction when the workpieces are made of stainless steel;
the tip of the TIG electrode is located a distance of between 36 and 44 mm from the first direction when the workpieces are made of carbon steel;
said first and second directions form an angle α of between 10° and 30°;
said first and second directions form an angle α of between 15° and 25°, preferably of between 18° and 23°, and advantageously of about 20°; and
the electrode comprises a conical taper to the tip of the electrode, the conical taper having an opening β of between 20° and 40°, which also allows the welding speed to be increased. This taper in general takes the form of a cone of revolution. The opening of this cone is defined as twice the angle between a generatrix and the axis of revolution of the cone.

The invention also relates to a process for arc welding metal workpieces (4) comprising steps of:

a) gradually producing a raw weld bead on the metal workpieces, i.e. along the joint plane to be welded, by means of a MIG/MAG welding torch, the torch being moved relative to said metal workpieces, in general in translation; and

b) applying an electric arc to at least part of the raw weld bead obtained in step a), the electric arc being produced by a TIG welding torch that is moved synchronously with the MIG/MAG welding torch,

characterized in that:
in step a), a consumable wire fed from the MIG/MAG torch is guided in a first direction that is substantially perpendicular to the workpieces to be welded; and
in step b), the TIG welding torch is oriented such that the electrode of said TIG torch points in a second direction that is substantially coplanar with the first direction and that forms an angle α of between 5° and 40° with said first direction, said TIG welding torch being moved so that the tip of the electrode remains a distance of between 20 and 44 mm from the first direction.

Specifically, step a) of the process is a conventional MIG/MAG welding step, intended to produce a “raw” weld bead as yet to undergo step b) of the process.

Moreover, step b) consists in treating the raw weld bead with an electric arc. More precisely, it involves creating an electric arc using the TIG torch and applying this arc to all or part of the bead located downstream of the point where it is formed by deposition of molten metal using the MIG/MAG torch.

Progressive treatment, by the arc, along the raw bead produces localized heating of the bead and an arc pressure effect, leading to a final weld bead that is free or almost free of humping, despite an increase in the welding speed.

Depending on the circumstances, the process of the invention may comprise one or more of the following features:
in step a) a consumable wire fed from the MIG/MAG torch is guided in a first direction that is substantially perpendicular to the workpieces to be welded, i.e. the metal workpieces present a surface toward the MIG or MAG torch and the first direction, i.e. that of the consumable wire as it exits the torch, is approximately orthogonal to the surface in question. It has been observed that this configuration is more favorable to slowing the appearance of humping;
in step b), the TIG welding torch is oriented such that the electrode of said TIG torch points in a second direction that is substantially coplanar with the first direction, i.e. they are approximately in the same plane. This allows the TIG torch to be applied symmetrically relative to the bead;
in step b), the TIG welding torch is oriented such that said second direction forms an angle α of between 0 and 40°, and preferably of between 5° and 30°, with the first direction.

According to a particular embodiment, this angle lies between 15° and 25°, preferably between 18° and 23°, and advantageously is about 20°;
in step b), the TIG welding torch is moved so that the tip of the electrode remains a distance of between 20 and 26 mm from the first direction;
the TIG welding torch uses an argon-comprising inert gas, preferably argon having a purity of at least 99 vol %. According to another particular embodiment, the purity is at least 99.99 vol %. The other constituents are then unavoidable impurities such as water vapor, oxygen, nitrogen, noble gases. Gases that may be used may be bought from Air Liquide;
alternatively, the TIG welding torch uses a gas formed by argon and at least 10 vol % hydrogen, typically a gas formed by argon and about 5% hydrogen;
workpieces made of stainless steel are welded, the tip of the electrode being positioned a distance of between 20 and 26 mm, preferably of about 24 mm, from the first direction;
workpieces made of carbon steel are welded, the tip of the electrode being positioned a distance of between 36 and 44 mm, preferably of about 40 mm, from the first direction;
the TIG arc and the MIG arc strike the one or more workpieces in a single common weld puddle;
the relative position, in distance and angle, of the TIG torch with respect to the MIG/MAG torch is adjusted in advance, before the welding operation is started, or is adjusted during the welding process. This adjustment may be permanent so as to tailor the set-up of the system to the workpieces to be welded and to the type of welding desired;
the TIG arc is obtained with a pulsed current, i.e. the nonconsumable tungsten electrode used to generate the TIG arc is supplied with a pulsed electric current; and
the TIG arc is obtained with a pulsed current and the MIG arc is obtained with a smooth current, i.e. the nonconsumable tungsten electrode used to generate the TIG arc is supplied with a pulsed electric current and, simultaneously, the MIG consumable electrode (consumable wire) is supplied with a smooth electric current.

Other particularities and advantages will become apparent on reading the following description, given with reference to the figures, in which:

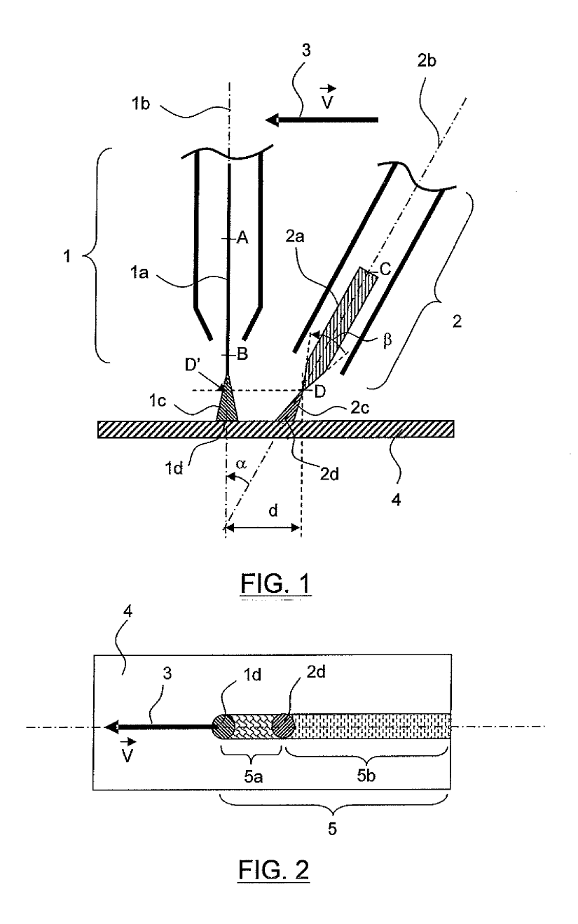

FIG. 1 shows a schematic of a welding device according to the invention, in particular the arrangement of the welding torches during operation; and

FIG. 2 shows a workpiece to be welded and illustrates what happens at the weld bead.

In FIG. 1, the metal workpieces 4 to be welded lie horizontal. The device comprises a MIG first welding torch 1. It extends vertically in a given first direction 1b, which is also the direction taken by a consumable wire 1a that exits from this torch when the latter is in operation. The wire 1a acts as an electrode. In operation, it is intended to create an electric arc 1c. The wire 1a melts, thereby allowing metal to be deposited in the location 1d on the metal workpieces 4. The torch 1 is moved with a velocity vector 3 relative to the metal workpieces 4. The deposition of metal in the zone 1d creates a raw weld bead 5a (see FIG. 2). The pay-out and wire-guide systems, the electrical power supply, the inert-gas supply and the means for controlling the torch 1 are known in the art and are not shown.

The device furthermore comprises a TIG second torch 2. It extends in a given second direction 2b, which is also that of its tungsten electrode 2a. The directions 1b and 2b are coplanar (they are located in the same plane). The electrode 2a comprises a tip D, at the end of a conical taper having an angular opening β of 30 degrees. The electrode 2a converges slightly toward the torch 1. More precisely, the angle α made by the directions 1b and 2b is 10 degrees. For the sake of clarity, the angle α shown in FIG. 1 is larger. The distance d between the tip D of the electrode 2a and the given first direction 1b is obtained by orthogonally projecting the point D onto the axis 1b and by measuring the distance DD'. This distance d is 22 millimeters.

In operation, the torch 2 allows an electric arc 2c to be generated, which arc is applied to the zone 2d of the weld bead 5 (see FIG. 2). The torch 2 follows the torch 1 in its movement, normally at the welding speed v.

As for the torch 1, the auxiliary electrical, gas-supply and mechanical components of the torch 2 have not been shown. The torches 1 and 2 are fastened in such a way as to be mechanically secured to each other and to allow their relative position, especially the angle α and the distance d, and their positive relative to the workpieces 4, to be adjusted at any moment.

FIG. 2 shows a top view of the workpieces 4 and the weld bead 5. When the device is in operation, molten metal is deposited in the zone 1d. By moving 3 the torch 1 at the welding speed v, this deposition gives rise to a raw weld bead 5a. The deposition zone 1d is at the head of the weld bead 5a. The treatment zone 2d allows a treated bead 5b to be obtained. All other things being equal, it is possible to move the torches 1 and 2 at a higher speed v without humping appearing in the part 5b of the weld bead 5.

Table A below shows the effect of certain parameters on the maximum welding speed v max that can be obtained without humping being observed in the bead 5b.

TABLE A
parameter study

| | d | α | β | TIG gas | TIG current | v max |
|---|---|---|---|---|---|---|
| # | (mm) | (°) | (°) | — | — | cm/min |
| 1 | 16 | 15 | 30 | Arcal 1 | C1 | 260 |
| | 16 | 40 | 30 | Arcal 1 | C1 | 260 |
| | 16 | −15 | 30 | Arcal 1 | C1 | 220 |
| | 16 | −40 | 30 | Arcal 1 | C1 | 220 |
| | 16 | 0 | 30 | Arcal 1 | C1 | 270 |
| 2 | 16 | 0 | 15 | Arcal 1 | C1 | 260 |
| | 16 | 0 | 45 | Arcal 1 | C1 | 260 |
| 3 | 16 | 0 | 30 | Arcal 1 | C2 | 280 |
| 4 | 14 | 0 | 30 | Arcal 1 | C2 | 260 |
| | 18 | 0 | 30 | Arcal 1 | C2 | 280 |
| | 22 | 0 | 30 | Arcal 1 | C2 | 320 |
| | 24 | 0 | 30 | Arcal 1 | C2 | 320 |
| | 26 | 0 | 30 | Arcal 1 | C2 | 280 |
| | 28 | 0 | 30 | Arcal 1 | C2 | 280 |
| 5 | 22 | 0 | 30 | Arcal 32 | C2 | 270 |
| | 22 | 0 | 30 | Arcal 37 | C2 | 280 |

The first column (#) shows the number of the test series. For each series, only one parameter (in bold) was varied:
Series #1: the angle α between the directions 1b and 2b. Positive values of the angle correspond to the cases where the consumable wire 1a and the nonconsumable electrode 2a converged towards each other. Negative values of this angle correspond to the cases where the electrode 2a and the wire 1a diverged from each other. It will be observed that negative values had a negative effect. A rather flat optimum was observed between 0 and 40°; 0° corresponding to directions 1b and 2b lying parallel. The direction 1b was in any case vertical;
Series #2: the angle β of the taper was varied. A rather flat optimum was observed between 20 and 40°;
Series #3: the type of current supplied to the electrode 2a of the TIG welding torch was varied. “C1” signifies that a constant current of 125 A was used. “C2” signifies that a pulsed current was used, the amplitude of the top-hat pulses of which was varied between 100 A and 150 A. The pulsed mode “C2” was slightly more favorable;
Series #4: the distance between the tip D of the electrode 2a, and the axis 2b of the MIG torch, was varied between 14 and 28 mm. A quite clear optimum range was observed between 20 and 26 mm; and
Series #5: in the other tests, the inert gas used in the TIG torch was commercially available Arcal 1 sold by Air Liquide, this gas being almost pure argon (purity higher than 99.998 vol %). In this series, two other gases were tested. Arcal 32 is essentially an argon/helium mixture, in which the fraction of helium by volume is 20 vol %. Arcal 37 is also an argon/helium mixture, in which the fraction of helium by volume is 70 vol %. As may be seen, the results obtained were better with Arcal 1 gas than with the mixtures Arcal 32 or Arcal 37.

The device and process for arc welding metal workpieces according to the invention may be used to weld metal workpieces made of various materials, namely, in particular, steel, stainless steel, aluminum and its alloys, titanium and its alloys, etc., whether or not these workpieces are coated with a superficial layer of zinc or aluminum, for example.

Additional trials, collated in table B, allowed the effect of the current type, namely a pulsed or smooth current, employed in the TIG torch to be verified.

TABLE B
comparison of smooth and pulsed currents

| | | | TIG process | TIG process | Vmax |
|---|---|---|---|---|---|
| d | α | β | gas | current | cm/min |
| 24 | 20 | 30 | Ar | C2 | 340 |
| 24 | 20 | 30 | Ar | C3 | 340 |
| 24 | 25 | 30 | Ar | C2 | 320 |
| 24 | 25 | 30 | Ar | C3 | 320 |
| 24 | 30 | 30 | Ar | C2 | 310 |
| 24 | 30 | 30 | Ar | C3 | 310 |
| 24 | 20 | 30 | Ar + 5% H₂ | C2 | 360 |
| 24 | 20 | 30 | Ar + 5% H₂ | C3 | 360 |

In table B, the current “C3” is a smooth current of 140 A. The results obtained clearly show that it is possible to obtain the same performance with a smooth current as with a pulsed current, providing the magnitude of the smooth current used is higher than that of the average of the pulsed-mode current.

In any case, the arc welding device and process using a MIG/MAG welding torch associated with a TIG welding torch, these torches operating simultaneously, allow weld joints to be obtained that are free from humping.

1-13. (canceled)

14. A device for arc welding metal at least two workpieces, the device comprising a first welding torch, comprising a MIG or MAG welding torch, in combination with a second welding torch, comprising a TIG welding torch, in a way allowing the first welding torch and the second welding torch to operate simultaneously, wherein said first welding torch comprises a wire guide allowing a consumable wire to be guided in a given first direction and the second welding torch comprises a nonconsumable electrode pointed in a given second direction, said first and second directions being substantially coplanar and forming an angle (α) larger than 10° and smaller than 40°, and the nonconsumable electrode comprises a tip (D) located a distance (d) of between 20 and 44 mm from said first direction.

15. The device of claim 14, wherein the tip (D) is located a distance (d) of between 20 mm and 26 mm from the first direction.

16. The device of claim 15, wherein the tip (D) is located a distance (d) of between 36 mm and 44 mm from the first direction.

17. The device of claim 14, wherein the first and second directions form an angle (α) of between 15° and 25°.

18. The device of claim 17, wherein the first and second directions form an angle (α) of between 18° and 23°

19. The device of claim 17, wherein the first and second directions form an angle (α) of 20°.

20. The device of claim 14, wherein the electrode comprises a conical taper to said tip (D), said conical taper having an opening (β) of between 20° and 40°.

21. A process for arc welding at least two metal workpieces comprising the steps of:
a) gradually producing a weld bead on the at least two metal workpieces by means of a first welding torch, comprising a MIG or MAG welding torch, with a consumable filler wire, the first torch being moved relative to said metal workpieces; and
b) applying an electric arc to at least part of the raw weld bead obtained in step a), the electric arc being produced by a second welding torch, comprising a TIG welding torch, that is moved synchronously with the first welding torch,
wherein:
in step a) a consumable wire fed from the first welding torch is guided in a first direction that is substantially perpendicular to the workpieces to be welded; and
in step b), the second welding torch is oriented such that the electrode of said second welding torch points in a second direction that is substantially coplanar with the first direction and that forms an angle (α) of between 5° and 40° with said first direction, said second welding torch being moved so that the tip of the electrode remains a distance of between 20 mm and 44 mm from the first direction.

22. The process of claim 21, wherein step b), said second welding torch is oriented such that said given second direction forms an angle (α) of between 15° and 25° with said first direction.

23. The process of claim 22, wherein step b), said second welding torch is oriented such that said given second direction forms an angle (α) of between 18° and 23o with said first direction.

24. The process of claim 22, wherein step b), said second welding torch is oriented such that said given second direction forms an angle (α) of about 20o with said first direction.

25. The process of claim 21, wherein the second welding torch uses an argon-comprising inert gas.

26. The process of claim 21, wherein the second welding torch uses argon having a purity of at least 99 vol % or a gas formed by argon and at least 10 vol % hydrogen.

27. The process of claim 21, wherein the at least two metal workpieces to be welded are made of stainless steel, the tip of the electrode being positioned a distance of between 20 and 26 mm from the first direction.

28. The process of claim 27, wherein the tip of the electrode is positioned a distance of about 24 mm from the first direction.

29. The process of claim 21, wherein the at least two metal workpieces to be welded are made of carbon steel, the tip of the electrode being positioned a distance of between 36 and 44 mm from the first direction.

30. The process of claim 29, wherein the tip of the electrode is positioned a distance of about 40 mm from the first direction.

31. The process of claim 21, wherein an arc from the second welding torch and an arc from the first welding torch strike the at least two workpieces in a single common weld puddle.

32. The process of claim 31, wherein the arc from the second welding torch is obtained with a pulsed current.

33. The process of claim 31, wherein the arc from the second welding torch is obtained with a pulsed current and the arc from the first welding torch is obtained with a smooth current.
